(19) United States
(12) Patent Application Publication
(10) Pub. No.: US 2025/0282495 A1
(43) Pub. Date: Sep. 11, 2025

(54) METHOD TO PROMOTE AIRCRAFT ELECTRIC POWER GENERATING SYSTEM FAULTS FROM LOWER SEVERITY TO HIGHER SEVERITY BASED ON FREQUENCY OF OCCURRENCE

(71) Applicant: Hamilton Sundstrand Corporation, Charlotte, NC (US)

(72) Inventors: Paul J. Peterson, Rockford, IL (US); Kamaraj Thangavelu, Rockford, IL (US); Abhay V. Munshi, Lake in the Hills, IL (US); Shashikant Vhasure, Palatine, IL (US); Mark J. Nauman, Winnebago, IL (US); Qiuming Leng, South Barrington, IL (US)

(21) Appl. No.: 18/596,297

(22) Filed: Mar. 5, 2024

(51) Int. Cl. B64F 5/60; G07C 5/00; G07C 5/08

(52) U.S. Cl. CPC B64F 5/60; G07C 5/006; G07C 5/0808; G07C 5/0825

(57) ABSTRACT

A fault analysis system is disclosed. The fault analysis system includes one or more processors configured to: continuously capture status signals corresponding to a plurality of fault events, wherein the plurality of fault events are associated with an electric power generating system of an aircraft; count a quantity of instances of a fault event of a target severity level with respect to a target quantity of flights, wherein the fault event is included in the plurality of fault events; generate a second fault event associated with the fault event based on comparing the quantity of the instances to a threshold quantity, wherein the second fault event is of a second severity level different from the target severity level; and report the second fault event according to the second severity level.

### BACKGROUND

The subject matter disclosed herein generally relates to fault events in an aircraft electric power generating system (EPGS), and more particularly to promotion of aircraft EPGS fault events from lower severity to higher severity based on frequency of occurrence.

In an aircraft EPGS, system fault events can be reported to the aircraft crew based on detected events. Techniques supportive of effective reporting are desired.

### BRIEF DESCRIPTION

A fault analysis system is disclosed, including: one or more processors configured to: continuously capture status signals corresponding to a plurality of fault events, wherein the plurality of fault events are associated with an electric power generating system of an aircraft; count a quantity of instances of a fault event of a target severity level with respect to a target quantity of flights, wherein the fault event is included in the plurality of fault events; generate a second fault event associated with the fault event based on comparing the quantity of the instances to a threshold quantity, wherein the second fault event is of a second severity level different from the target severity level; and report the second fault event according to the second severity level.

Any one or combination of the foregoing embodiments, further including: a memory device including a circular buffer, wherein the one or more processors are configured to continuously store the status signals to the circular buffer.

Any one or combination of the foregoing embodiments, wherein the one or more processors are configured to classify the plurality of fault events according to respective severity levels of the plurality of fault events.

Any one or combination of the foregoing embodiments, wherein the one or more processors are further configured to: add the second fault event to the plurality of fault events; order the plurality of fault events based on respective severity levels of the plurality of fault events; and display the plurality of fault events based on the order.

Any one or combination of the foregoing embodiments, wherein: the target severity level includes a lowest severity level; and the second severity level is higher than the target severity level.

Any one or combination of the foregoing embodiments, further including: one or more rule based tables, wherein the one or more processors are configured to generate the second fault event based on the fault event and the one or more rule based tables.

Any one or combination of the foregoing embodiments, wherein: the one or more processors are configured to assign the second severity level to the second fault event.

Any one or combination of the foregoing embodiments, wherein: the one or more processors are configured to generate a database entry corresponding to the fault event and store the database entry to a database; and the one or more processors are configured to generate a second database entry corresponding to the second fault event and store the second database entry to the database.

Any one or combination of the foregoing embodiments, wherein: the one or more processors are configured to generate first timestamp data associated with the fault event and second timestamp data associated with generation of the second fault event; and the one or more processors are configured to display the fault event and the second fault event based on the first timestamp data and the second timestamp data.

Any one or combination of the foregoing embodiments, wherein the one or more processors are further configured to: generate one or more second corrective actions associated with the second fault event, wherein at least a portion of the one or more second corrective actions associated with the second fault event is different from one or more correction actions associated with the fault event.

Any one or combination of the foregoing embodiments, wherein the one or more processors are further configured to: determine a pattern associated with the instances of the fault event; and generate the second fault event based on comparing the pattern to a target pattern.

An apparatus is disclosed, including: a controller including one or more processors and logic circuitry, wherein: processing circuitry of the one or more processors is configured to continuously capture status signals corresponding to a plurality of fault events, wherein the plurality of fault events are associated with an electric power generating system of an aircraft; the logic circuitry is configured to count a quantity of instances of a fault event of a target severity level with respect to a target quantity of flights, wherein the fault event is included in the plurality of fault events; the processing circuitry is configured to generate a second fault event associated with the fault event based on comparing, by the logic circuitry, the quantity of the instances to a threshold quantity, wherein the second fault event is of a second severity level different from the target severity level; and the processing circuitry is configured to report the second fault event according to the second severity level.

Any one or combination of the foregoing embodiments, further including: a memory device including a circular buffer, wherein the processing circuitry is configured to continuously store the status signals to the circular buffer.

Any one or combination of the foregoing embodiments, wherein the logic circuitry is configured to classify the plurality of fault events according to respective severity levels of the plurality of fault events.

Any one or combination of the foregoing embodiments, wherein the processing circuitry is configured to: add the second fault event to the plurality of fault events; order the plurality of fault events based on respective severity levels of the plurality of fault events; and display the plurality of fault events based on the order.

A method is disclosed, including: continuously capturing, by one or more circuitry, status signals corresponding to a plurality of fault events, wherein the plurality of fault events are associated with an electric power generating system of an aircraft; counting, by the one or more circuitry, a quantity of instances of a fault event of a target severity level with respect to a target quantity of flights, wherein the fault event is included in the plurality of fault events; generating, by the one or more circuitry, a second fault event associated with the fault event based on comparing the quantity of the instances to a threshold quantity, wherein the second fault event is of a second severity level different from the target severity level; and reporting, by the one or more circuitry, the second fault event according to the second severity level.

Any one or combination of the foregoing embodiments, further including: continuously storing, by the one or more circuitry, the status signals to a circular buffer.

Any one or combination of the foregoing embodiments, further including: classifying, by the one or more circuitry, the plurality of fault events according to respective severity levels of the plurality of fault events.

Any one or combination of the foregoing embodiments, further including: adding, by the one or more circuitry, the second fault event to the plurality of fault events; ordering, by the one or more circuitry, the plurality of fault events based on respective severity levels of the plurality of fault events; and displaying, by the one or more circuitry, the plurality of fault events based on the ordering.

Any one or combination of the foregoing embodiments, wherein: the target severity level includes a lowest severity level; and the second severity level is higher than the target severity level.

### BRIEF DESCRIPTION OF THE DRAWINGS

The following descriptions should not be considered limiting in any way. With reference to the accompanying drawings, like elements are numbered alike.

FIG. 1 is a schematic illustration of a system that can incorporate various embodiments of the present disclosure.

FIG. 2 is an example flowchart supportive of promotion of aircraft EPGS fault events from lower severity to higher severity in accordance with example aspects of the present disclosure.

FIG. 3 illustrates an example flowchart of a method that supports promotion of aircraft EPGS fault events from lower severity to higher severity in accordance with one or more embodiments of the present disclosure.

### DETAILED DESCRIPTION

A detailed description of one or more embodiments of the disclosed apparatus and method are presented herein by way of exemplification and not limitation with reference to the Figures.

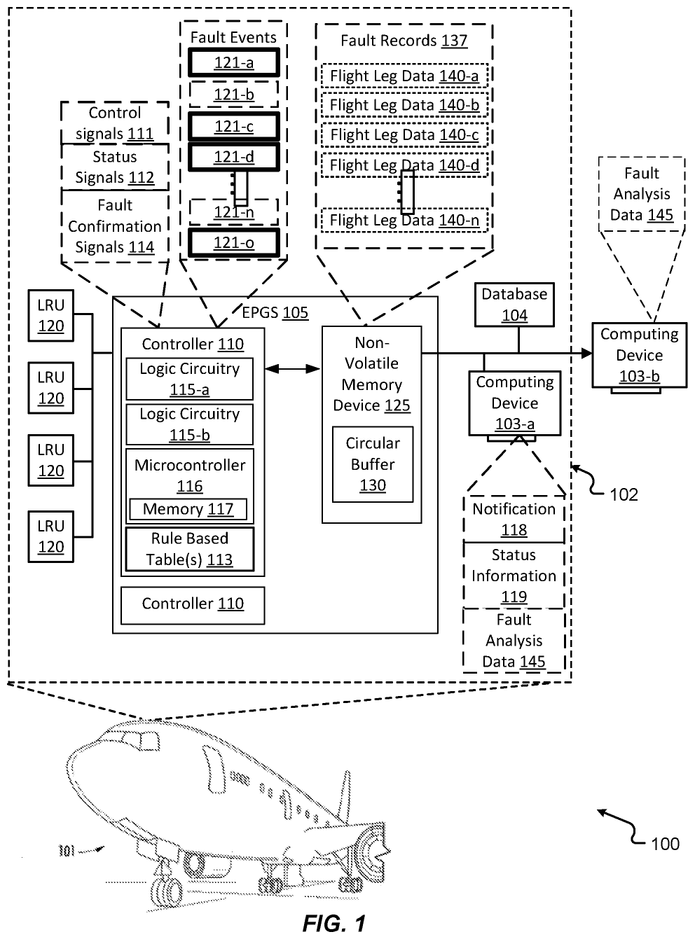

FIG. 1 is a schematic illustration of a system 100 that can incorporate various embodiments of the present disclosure. As shown in FIG. 1, the system 100 may include an aircraft 101 and one or more computing devices 103.

According to one or more embodiments of the present disclosure, the system 100 may support fault reporting and fault analysis by the aircraft system 102. The system 100 may support fault reporting and fault analysis by a computing device 103-a or computing device 103-b (e.g., based on data provided by the aircraft system 102).

The computing devices 103 may be capable of performing any combination of operations described herein. In some cases, the system 100 may include computing devices 103 internal to and integrated with the aircraft system 102 and computing devices 103 separate from the aircraft system 102. Components of the aircraft system 102 described herein may be electrically coupled via any combination of buses (not illustrated) (e.g., power buses, data buses, avionics buses, or the like).

A computing device 103 (e.g., computing device 103-a, computing device 103-b) may be disposed in operable communication with components of the aircraft 101. The system 100 and aircraft system 102 supports communication between the computing devices 103 and other devices of the system 100 via wired communication protocols, wireless communication protocols (e.g., electromagnetic (EM) signals, WiFi, Bluetooth™, ZigBee™, Ubiquiti™, 3G, 4G, LTE, and the like), and/or combinations including one or more of the foregoing.

The computing device 103 is configured to receive, store and/or transmit data. The computing device 103 includes processing components configured to analyze received signals and data described herein. The computing device 103 includes processing components configured to provide data (and/or control signals) to other components of the system 100 or aircraft system 102. The computing device 103 includes any number of suitable components, such as processors, memory, communication devices and power sources.

The computing device 103 may include processing circuitry capable of executing instructions stored on a memory of the computing device 103 in association with performing one or more functions described herein. Some elements stored in the memory may be described as or referred to as instructions or instruction sets, and some functions of the computing device 103 may be implemented using machine learning techniques.

The aircraft 101 can include an EPGS 105. The EPGS 105 may include an EPGS controller 110. In some examples, logic circuitry 115-a may be implemented in the EPGS controller 110. The logic circuitry 115-a may be, for example, built-in test equipment (BITE) logic. In some embodiments, the EPGS 105 may include multiple EPGS controllers 110. It is to be understood that aspects described herein with reference to a EPGS controller 110 may be applied to other EPGS controllers 110 included in the EPGS 105.

The EPGS controller 110 may include microcontroller 116 (or multiple microcontrollers 116). Each of the EPGS controller 110 and the microcontroller 116 may correspond to one or many computer processing devices. For example, may include a silicon chip, such as a FPGA, an ASIC, any other type of IC chip, a collection of IC chips, or the like. In some aspects, the processors may include a microprocessor, CPU, a GPU, or plurality of microprocessors configured to execute the instructions sets stored in a corresponding memory (e.g., memory 117 of the microcontroller 116). For example, upon executing the instruction sets stored in memory 117, the microcontroller 116 may enable or perform one or more functions described herein. Some elements stored in memory 117 may be described as or referred to as instructions or instruction sets.

The memory 117 may include one or multiple computer memory devices. The memory 117 may include, for example, Random Access Memory (RAM) devices, Read Only Memory (ROM) devices, flash memory devices, magnetic disk storage media, optical storage media, solid state storage devices, core memory, buffer memory devices, combinations thereof, and the like. The memory 117, in some examples, may correspond to a computer readable storage media. In some aspects, the memory 117 may be internal or external to the EPGS controller 110 and/or the microcontroller 116.

The memory 117 may be configured to store instruction sets and other data structures (e.g., depicted herein) in addition to temporarily storing data for the microcontroller 116 to execute various types of routines or functions. For example, the memory 117 may be configured to store program instructions (instruction sets) that are executable by the microcontroller 116 and provide functionality of the EPGS controller 110 described herein. The memory 117 may also be configured to store data or information that is useable or capable of being called by the instructions stored in memory 117.

The aircraft system 102 may include a database 104. The aircraft system 102 supports storing and/or accessing data described herein (e.g., status signals 112, fault-confirmation signals 114, fault events 121, status information 119, fault records 137, fault analysis data 145, and the like, example aspects of which will be described herein) via the database 104.

The EPGS controller 110 may include logic circuitry 115-b configured to promote respective severity levels of one or more fault events (also referred to herein as faults), example aspects of which as described herein. The logic circuitry 115-b may be referred to herein as promotion logic.

In some embodiments, the logic circuitry 115-b logic may be provided by the EPGS controller 110 through a data-only configuration file (e.g., a parameter data item). The data-only configuration file may support flexibility in the tuning of the logic circuitry 115-b without impacting the certification baseline of the EPGS controls. The aircraft system 102 supports updating the logic circuitry 115-b via one or more data files (not illustrated). For example, the aircraft system 102 supports providing a data file update to the EPGS controls based on an update schedule, for example, in a manner similar to avionics navigation database monthly updates.

In some examples, the data file may include one or more tables of configuration information for the logic circuitry 115-b. In some other examples, the data file may include a fault catalog including correlations between faults and associated causes (e.g., performance parameters of an LRU 120, status signals 112 associated with an LRU 120, or the like). In some examples, the fault catalog may be implemented in one or more rule based tables 113.

The aircraft 101 may include multiple line replaceable units (LRUs) 120 electrically coupled to the EPGS 105. The LRUs 120 may be coupled to the EPGS 105 via one or more data buses. Non-limiting examples of the LRUs 120 include generators, contactors, controllers, switches, wiring, sensors, and the like.

The EPGS 105 may include a non-volatile memory (NVM) device 125 capable of storing data. Aspects of the present disclosure include implementing a circular buffer 130 in the NVM device 125. The circular buffer 130 (also referred to herein as a circular queue, a cyclic buffer, or a ring buffer) is a data structure that uses a single buffer as if the buffer were connected end-to-end. The size of the circular buffer 130 may be a fixed size or may be tunable by the system 100.

The circular buffer 130 may have a predetermined storage space. In some cases, the circular buffer 130 may be capable of continuously storing data. For example, a property of the circular buffer 130 is that when the circular buffer 130 is full and a subsequent writing of data to the circular buffer 130 is performed, the data write may overwrite the oldest data stored on the circular buffer 130. In some aspects, the techniques described herein include setting the storage space of the circular buffer 130 based on one or more criteria.

According to one or more embodiments of the present disclosure, the system 100 supports promoting the severity of fault events associated with the aircraft 101. The techniques described support reclassifying fault events (e.g., as being relatively less severe to relatively more severe) based on one or more criteria. The reclassifying of fault events may support improving accuracy, efficiency, and predictive analysis associated with system troubleshooting of the aircraft 101. References herein to reclassifying fault events may include the promotion of fault events and the generation of additional fault events (e.g., of higher severity) from existing fault events (e.g., of relatively less severity), example aspects of which are described herein.

The terms ‘faults’, ‘fault events’, ‘system faults,’ and ‘system fault events’ may be used interchangeably herein. In some examples, the terms may refer to faults associated with the aircraft system 102. For example, in some cases, the terms may refer to faults associated with the EPGS 105 and LRUs 120. Descriptions with reference to the ‘faults’, ‘fault events’, and ‘system faults’ may include occurrences of a fault (e.g., generator overvoltage), reporting of the fault (e.g., by the EPGS 105, the aircraft system 102, or the like), and/or generation of an additional fault (e.g., based on promotion or reclassification of an existing fault as described herein).

In some aspects, the aircraft system 102 supports reporting of fault events at different levels to the aircraft crew (e.g., pilots, maintenance crew, and the like) based on severity of the event being detected. For example, in response to a fault event of generator overvoltage, the aircraft system 102 (e.g., at EPGS 105) may remove the generating channel from the aircraft network in order to protect the aircraft 101 from the fault event. In an example, the aircraft system 102 (e.g., at computing device 103-a) may generate and output a notification 118 (e.g., an audible, visible, and/or haptic notification via one or more displays or computing devices 103) associated with the fault event. The notification 118 may be text-based, graphics based, or the like. For example, the aircraft system 102 may generate and output a notification 118 to the cockpit as a pilot crew warning action (e.g., ‘Electric Generator Offline’).

The aircraft system 102 supports monitoring and reporting of fault events of different levels of severity. For example, the aircraft system 102 supports reporting fault events with a notification 118 for additional pilot crew workload to monitor and/or address the fault event. For example, for a fault event of relatively less severity (e.g., an elevated generator oil temperature), the aircraft system 102 may generate and output a corresponding notification 118 (e.g., ‘Oil Temperature Advisory’).

In some aspects, the aircraft system 102 supports providing status information 119 (e.g., ‘Generator Low Oil Level’), which in some cases, may be more relevant to the maintenance crew than to the pilot crew. The EPGS 105 is capable of communicating data (e.g., status signals 112 (later described herein), fault-confirmation signals 114 (later described herein), notifications 118, status information 119, and the like) indicative of warning/advisory/status events within the aircraft system 102. In some aspects, the EPGS 105 is capable of storing data associated with the warning/advisory/status events in NVM device 125 as fault records 137 usable by the system 100 (or an operator of the system 100) for troubleshooting of the aircraft system 102.

According to one or more embodiments of the present disclosure, in response to a fault event at the aircraft 101 (e.g., at a LRU 120), the EPGS controller 110 may isolate the reason for the fault event to the most relevant LRU 120 in the aircraft system 102. In some examples, the fault event may be due to one or more fault conditions, example aspects of which are later described herein.

In an example, circuitry in the EPGS controller 110 may provide control signals 111 to microcontroller 116 to consume. For example, the EPGS controller 110 provides, in digital form (e.g., control signals 111), conditions of switches and measurement data (e.g., temperatures, pressures, and the like) to microcontroller 116 to consume. Based on the control signals 111, the microcontroller 116 may produce status signals 112.

The EPGS controller 110 (processor) may act on the status signals 112 to determine whether a fault condition is present. For example, the EPGS controller 110 (e.g., using logic circuitry 115-a) may generate and output a fault-confirmation signal 114 indicating the presence of the fault condition. That is, for example, the EPGS controller 110 may generate a fault code (e.g., a fault-confirmation signal 114) for confirming the fault event. In an example, a fault event may include a generator failure associated with the aircraft system 102, but is not limited thereto.

Non-limiting examples of the status signals 112 include voltages, currents, frequencies, temperatures, internal controller statuses, switches, contactors, and the like.

The aircraft system 102 provides increased effectiveness compared to other techniques for reporting of fault events by an EPGS. For example, some other techniques for EPGS reporting may collect and store events/faults by flight legs, with little to no correlation of faults across flight legs.

According to one or more embodiments of the present disclosure, the EPGS 105 is configured to apply additional logic equations (e.g., implemented by logic circuitry 115-b) by searching fault records 137 and promoting faults (e.g., lower-level faults, mid-level faults, or the like) to a greater severity level based on a frequency of occurrence of the faults with respect to a target quantity of flight legs (and/or with respect to a time period). In some embodiments, the EPGS 105 may search the fault records 137 in response to one or more trigger criteria.

Non-limiting examples of the trigger criteria include any one or a combination of a threshold temporal condition (e.g., every 12 hours, every day, every week, or the like), a threshold quantity of flights (e.g., every 2 flights, every 4 flights, or the like), and a user input. Accordingly, for example, the EPGS 105 may autonomously and/or semi-autonomously perform the techniques described herein.

In some aspects, the logic circuitry 115-b is configured to count the quantity of instances of faults over a given number of flight legs. For example, the EPGS 105 (e.g., using the logic circuitry 115-b) may determine, from any quantity of flight leg data 140, the quantity of instances of faults over a given number of flight legs. In an example, each instance of flight leg data 140 may be associated with a flight leg (e.g., a flight originating at a first location and ending at a second location).

Among the faults, the EPGS 105 (e.g., using the logic circuitry 115-b) may analyze any faults of a severity level less than or equal to a target severity level. Non-limiting examples of the target severity level may include low severity (e.g., a low-level fault), medium severity (e.g., a mid-level fault), high severity (e.g., a high-level fault), and severity levels between any of the low, medium, or high severity levels. In some aspects, the system 100 supports using a scoring metric (e.g., a numerical score) for indicating severity level.

In response to identifying that a target fault of a given severity level (e.g., low-level fault) exceeds a frequency of occurrence with respect to a target quantity of flight legs (and/or with respect to a time period), the EPGS 105 may promote the target fault event to a relatively higher severity level. For example, the EPGS 105 may assign a higher severity level to the fault event.

In some aspects, the EPGS 105 may report the fault as a new fault and include the new fault in the fault records 137. That is, for example, based on the fault, the EPGS 105 (e.g., by controller 110) may generate the new fault. Accordingly, for example, the aircraft system 102 (e.g., via computing device 103-a) may list or display the new fault among faults to be resolved, at a higher priority position compared to the original fault, example aspects of which will be described herein. In some examples, the EPGS 105 may apply the logic equations specific to consider target requirements of the EPGS 105 for a given aircraft type, and may include specific logic considerations from aircraft operator input. It is to be understood that descriptions of operations performed by the aircraft system 102 may include performance of the operations by one or more components (e.g., computing device 103-a, EPGS 105, controller 110, and the like) included in the aircraft system 102.

In an example implementation, the EPGS 105 may have identified and reported a relatively low severity fault (e.g., generator oil level status: low oil) every 3 or 4 flights. For example, among flight leg data 140-a through flight leg data 140-n (where each instance of flight leg data 140 corresponds to a completed flight), every 3rd or 4th instance of flight leg data 140 may include the same relatively low severity fault.

The EPGS 105 (e.g., using logic circuitry 115-b) may compare the quantity of the relatively low severity fault to a threshold quantity of instances. In response to a comparison result in which the quantity is greater than or equal to the threshold quantity of instances, the EPGS 105 (e.g., using the logic circuitry 115-b) may promote the relatively low severity fault (e.g., assign a higher severity level to the fault). For example, the EPGS 105 may generate and report a fault of the higher severity level (also referred to herein as a higher severity fault).

In some examples, reporting the higher severity fault may include displaying the fault according to a higher priority compared to faults of a relatively lower severity level. In some examples, reporting the higher severity fault may include displaying (e.g., on a display screen) the higher severity fault in combination with one or more visual indicators (e.g., color highlighting, bold text) representative of the higher severity level. In some examples, the one or more visual indicators may be representative of the change in severity level (e.g., the promotion to the higher severity level) for the fault. For example, the one or more visual indicators may indicate that the higher severity fault has been newly generated based on a different fault (e.g., the lower severity fault).

In the example implementation, for the higher severity fault, the aircraft system 102 may generate or display a notification 118 including an advisory or warning level message ‘Persistent Generator Cooling System Oil Leak’. In some cases, though addressing the persistent generator cooling system oil leak through repairs and/or equipment replacement may involve a relatively larger amount of maintenance action compared to other actions (e.g., adding oil to the generator cooling system), the overall cost associated with the repairs and/or equipment replacement may be less than the overall cost associated with repeatedly performing actions for addressing the related low severity fault. For example, repair and/or replacement of the generator cooling system may be cumulatively less time-consuming and less expensive (e.g., due to a resulting reduction in maintenance hours and/or a reduction in consumables (oil)) compared to having a maintenance crew service the generator cooling system and replace the oil every 3 to 4 flights.

As an example operational flow, the aircraft system 102 generates a notification 118 instructing the crew to troubleshoot the generator cooling system. The aircraft system 102 may present the notification 118 via a computing device 103-a onboard the aircraft system 102 and/or a computing device 103-b (e.g., a portable computing device, a workstation, or the like) separate from the aircraft system 102. In some examples, the aircraft system 102 may transmit data corresponding to the higher severity fault and the notification 118 to the computing device 103-b, and the computing device 103-b may display the notification 118.

Based on the troubleshooting, the crew finds a leak in a cooling system fitting. The crew performs the associated actions to resolve the leak. In response to the resolution of the leak, the aircraft system 102 may reset the notification 118 in the EPGS controls to complete the action. In some examples, the aircraft system 102 may reset the notification 118 in response to a user input confirming that the actions have been completed. Additionally, or alternatively, the aircraft system 102 may reset the notification 118 in response to detecting through sensor data or the status signals 112 that the leak has been resolved.

The systems and techniques described herein provide improvements compared to other systems and approaches for attending to faults in an aircraft 101. For example, for the example case of the relatively low severity fault, some other systems and approaches merely include servicing the low severity fault by a maintenance crew (e.g., the maintenance crew services the generator oil level by adding oil) each time the fault is reported to address the issue. Accordingly, for example, by failing to analyze the occurrence frequency of the relatively low severity fault and failing to promote the severity, such other systems and approaches may accordingly fail to recognize or suggest alternative and/or additional actions (e.g., repair and/or replacement of equipment) which may otherwise result in a reduced overall cost and increased safety.

Further, for example, by failing to analyze the occurrence frequency of the relatively low severity fault and failing to promote the severity, such other systems and approaches may accordingly fail to effectively troubleshoot and identify a larger or hidden fault (e.g., leak in a cooling system fitting) that is causing or is associated with the relatively low severity fault. For example, the systems and techniques described herein may support identifying, from relatively low severity faults (e.g., bolts which are reported as loose every 3 to 4 flights and are then tightened by maintenance crew), a related larger issue or defect to be addressed.

The systems and techniques described herein further support increased efficiency through enhanced troubleshooting of faults and identifying potential larger or hidden faults. For example, some other approaches may fail to automatically recognize that a relatively low severity fault is being caused by a larger or hidden fault. For example, some other approaches may rely on manual review of a maintenance logbook or records by maintenance staff, which is more time intensive, less efficient, and less accurate compared to the techniques described herein.

In some embodiments, the aircraft system 102 may provide the fault records 137 to a computing device 103 (e.g., computing device 103-a, computing device 103-b, or the like). Based on processing the fault records 137, the computing device 103 may generate fault analysis data 145 including the notification 118 described herein. In some embodiments, the computing device 103 may promote the relatively low severity fault and/or identify the larger or hidden fault based on processing the fault records 137.

In some embodiments, the fault analysis data 145 may include a correlation between the relatively low severity fault and the identified larger or hidden fault. In some embodiments, using the fault analysis data 145, the system 100 may support determining a correlation between relatively high severity faults and candidate faults of lower severity. Accordingly, for example, the system 100 may support effective determination and identification of potentially costly high severity faults from repeated instances of relatively lower severity faults. Accordingly, for example, the techniques described herein provide more effective and more accurate insight of fault events compared to other techniques which fail to incorporate promotion and prioritization of lower severity faults as described herein.

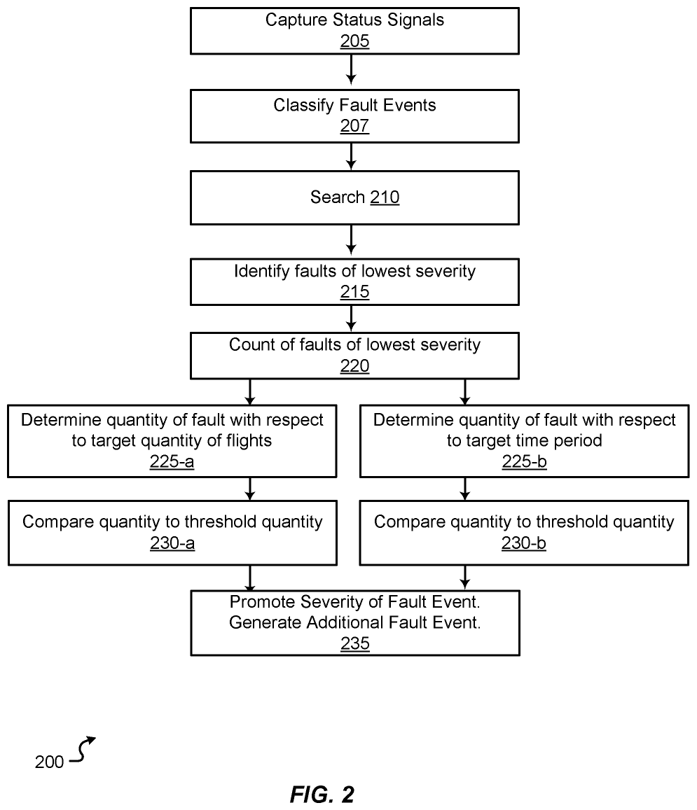

FIG. 2 illustrates an example flowchart of a method 200 in accordance with one or more embodiments of the present disclosure. The method 200 may be implemented by aircraft system 102 (e.g., at EPGS 105) and/or a computing device 103 described with reference to FIG. 1.

At 205, the method 200 may include capturing status signals 112 corresponding to fault events 121. In some examples, the method 200 may include continuously capturing status signals 112 corresponding to fault events 121. In an example, the fault events 121 are associated with the EPGS 105 and/or LRUs 120 as described herein. In some aspects, the EPGS 105 (e.g., controller 110) is configured to continuously store the status signals 112 to the circular buffer 130.

In an example, the circular buffer 130 may be capable of storing status signals 112 for a duration equal to a temporal period (e.g., based on available memory of the circular buffer 130). When the circular buffer 130 is full and a subsequent writing of data to the circular buffer 130 is performed, the data write may overwrite the oldest data stored on the circular buffer 130.

At 207, the method 200 may include classifying the fault events 121 according to respective severity levels of the fault events 121. For example, in some embodiments, the EPGS 105 (e.g., using logic circuitry 115-a and/or the logic circuitry 115-b) is configured to classify the fault events 121 according to respective severity levels (e.g., low severity, medium severity, high severity, or the like) of the fault events 121. In some aspects, the EPGS 105 (e.g., using logic circuitry 115-a and/or the logic circuitry 115-b) is configured to classify the fault events 121 using a scoring metric for indicating the severity levels.

At 210, the method 200 may include searching the circular buffer 130 for status signals 112. In some embodiments, the method 200 may include searching the circular buffer 130 based on a target temporal period (e.g., the past X hours, the past X days, the past X weeks, or the like). In some embodiments, the system 100 is configured to set or tune the target temporal period. In some embodiments, the method 200 may include searching the circular buffer 130 based on one or more other criteria (e.g., upon completion of a flight by the aircraft 101).

The EPGS 105 may be configured to identify fault events 121 according to severity level. For example, at 215, the method 200 may include identifying, from among the fault events 121 found based on the search, fault events 121 of a target severity level. In an example, at 215, the method 200 may include identifying fault events 121 of a lowest severity level.

At 220, the method 200 may include counting the quantity of the fault events 121 of the target security level, for example, the lowest severity level. In an example, with reference to FIG. 1, the EPGS 105 (e.g., using logic circuitry 115-b) may identify that fault event 121-a, fault event 121-b, and fault event 121-d (respectively included in flight leg data 140-a, flight leg data 140-b, and flight leg data 140-d) are the same fault event 121 (same type of fault event 121) (e.g., ‘Generator Low Oil Level’) and are all of the lowest severity level. In the example, the quantity of instances of the same fault event 121 (e.g., ‘Generator Low Oil Level’) is 3.

In some embodiments, the EPGS 105 (e.g., logic circuitry 115-b) is configured to determine the quantity of instances of the same fault event 121 with respect to a target quantity of flights (e.g., the four most recent flights). For example, at 225-a, the method 200 may include counting, with respect to flight leg data 140-a through flight leg data 140-d (e.g., four flights), a quantity of times that the same fault event 121 (e.g., ‘Generator Low Oil Level’) occurs. In the example, the EPGS 105 (e.g., using logic circuitry 115-b) may identify that the same fault event 121 (e.g., ‘Generator Low Oil Level’) occurred three times over the past four flights corresponding to flight leg data 140-a through flight leg data 140-d.

In the example described herein, the flights include the four most recent flights. However, aspects of the present disclosure are not limited thereto, and the method 200 supports determining the quantity of instances of the same fault event 121 with respect to a target quantity of flights, for any time period. Non-limiting examples include the four most recent consecutive flights, every other flight (for a total of eight flights) during a target month, and the like.

Additionally, or alternatively, at 225-b, the method 200 may include counting, with respect to the target time period associated with the search at 210, a quantity of times that the same fault event 121 (e.g., ‘Generator Low Oil Level’) occurs. In some embodiments, the method 200 may include counting, with respect to any suitable time period (e.g., a time period different from the target time period associated with the search at 210), a quantity of times that the same fault event 121 (e.g., ‘Generator Low Oil Level’) occurs.

At 235, the method 200 may include promoting the severity of the target fault event 121 based on comparing (at 230-a or at 230-b) the quantity of the instances to a threshold quantity. In an example of promoting the severity of the target fault event 121, the EPGS 105 is configured to generate an additional fault event 121 (e.g., a fault event 121-o) associated with the same fault event 121 (e.g., fault event 121-a, fault event 121-b, and fault event 121-d).

In the example, fault event 121-o is of a higher severity level compared to the severity levels of fault event 121-a, fault event 121-b, and fault event 121-d. In an example, the EPGS 105 (e.g., using logic circuitry 115-b) is configured to assign the higher severity level to the fault event 121-o.

In some embodiments, the aircraft system 102 may report the fault event 121-o according to the higher severity level. For example, the aircraft system 102 may add the fault event 121-o to the fault events 121.

In some aspects, the aircraft system 102 (e.g., at EPGS 105 and/or at computing device 103-a) may order the fault events 121 based on respective severity levels of the fault events 121 and display the fault events 121 based on the order. For example, each fault event 121 may be a database entry. The aircraft system 102 may report the fault event 121-o as a new fault of the higher severity level, and the aircraft system 102 may add the fault event 121-o to a data log including the fault events 121, such that the fault event 121-o is after fault event 121-n.

In some embodiments, the aircraft system 102 is configured to generate respective database entries corresponding to recorded fault events 121 (e.g., fault event 121-a through fault event 121-n) and fault events 121 (e.g., fault event 121-o) generated in accordance with the example techniques described herein. The aircraft system 102 is configured to store the database entries to database 104.

In some embodiments, the aircraft system 102 is configured to generate timestamp data respectively corresponding to recorded fault events 121 (e.g., fault event 121-a through fault event 121-n) and fault events 121 (e.g., fault event 121-o) generated in accordance with the example aspects of the present disclosure. In some aspects, the aircraft system 102 and/or the computing device 103-b may display the fault events 121 based on respective timestamp data.

In some embodiments, the aircraft system 102 is configured to generate one or more corrective actions associated with a generated fault event 121 (e.g., fault event 121-o). For example, in a case in which the fault event 121-o is a ‘Persistent Generator Cooling System Oil Leak,’ the aircraft system 102 may generate corrective actions such as, for example, actions for troubleshooting and/or addressing the oil leak.

In some embodiments, the computing devices 103 (e.g., computing device 103-a, computing device 103-b) are configured to generate fault analysis data 145 associated with the fault event 121-o. In some examples, the fault analysis data 145 may include corrective actions for addressing any of the fault events 121. Aspects of the present disclosure support generating the fault analysis data 145 autonomously and/or semi-autonomously.

In some embodiments, the aircraft system 102 may transmit data or information described herein to the computing device 103-b. In some other embodiments, the system 100 supports transferring (e.g., via wired or wireless data transmission) data or information described herein to the computing device 103-b via electrical coupling to the NVM device 125 or electrical coupling to another suitable removable memory storage device on which data or information may be stored. For example, the system 100 supports data dumps of raw unfiltered data from the aircraft system 102 to the computing device 103-b, based on which the computing device 103-b may generate the fault analysis data 145.

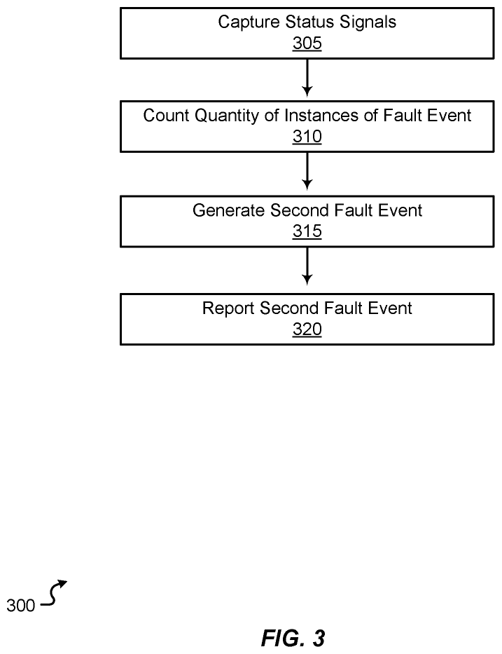

FIG. 3 illustrates an example flowchart of a method 300 that supports enhanced troubleshooting of aircraft EPGS fault events in accordance with one or more embodiments of the present disclosure. The method 300 may be implemented by aircraft system 102 and/or a computing device 103 described with reference to FIG. 1.

At 305, the method 300 includes continuously capturing, by one or more circuitry, status signals corresponding to a plurality of fault events, wherein the plurality of fault events are associated with an electric power generating system of an aircraft.

At 310, the method 300 includes counting, by the one or more circuitry, a quantity of instances of a fault event of a target severity level with respect to a target quantity of flights, wherein the fault event is included in the plurality of fault events.

At 315, the method 300 includes generating, by the one or more circuitry, a second fault event associated with the fault event based on comparing the quantity of the instances to a threshold quantity, wherein the second fault event is of a second severity level different from the target severity level.

At 320, the method 300 includes reporting, by the one or more circuitry, the second fault event according to the second severity level.

In some aspects, the method 300 may include continuously storing, by the one or more circuitry, the status signals to a circular buffer.

In some aspects, the method 300 may include classifying, by the one or more circuitry, the plurality of fault events according to respective severity levels of the plurality of fault events.

In some aspects, the method 300 may include adding, by the one or more circuitry, the second fault event to the plurality of fault events. In some aspects, the method 300 may include ordering, by the one or more circuitry, the plurality of fault events based on respective severity levels of the plurality of fault events. In some aspects, the method 300 may include displaying, by the one or more circuitry, the plurality of fault events based on the ordering.

In some aspects, the target severity level includes a lowest severity level. In some aspects, the second severity level is higher than the target severity level.

In the descriptions of the flowcharts herein, the operations may be performed in a different order than the order shown, or the operations may be performed in different orders or at different times. Certain operations may also be left out of the flowcharts, one or more operations may be repeated, or other operations may be added to the flowcharts.

Set forth are embodiments supported by the present disclosure.

Embodiment 1. A fault analysis system, comprising: one or more processors configured to: continuously capture status signals corresponding to a plurality of fault events, wherein the plurality of fault events are associated with an electric power generating system of an aircraft; count a quantity of instances of a fault event of a target severity level with respect to a target quantity of flights, wherein the fault event is included in the plurality of fault events; generate a second fault event associated with the fault event based on comparing the quantity of the instances to a threshold quantity, wherein the second fault event is of a second severity level different from the target severity level; and report the second fault event according to the second severity level.

Embodiment 2. The fault analysis system of Embodiment 1, further comprising: a memory device comprising a circular buffer, wherein the one or more processors are configured to continuously store the status signals to the circular buffer.

Embodiment 3. The fault analysis system of Embodiment 1 or Embodiment 2, wherein the one or more processors are configured to classify the plurality of fault events according to respective severity levels of the plurality of fault events.

Embodiment 4. The fault analysis system of any of Embodiment 1 through Embodiment 3, wherein the one or more processors are further configured to: add the second fault event to the plurality of fault events; order the plurality of fault events based on respective severity levels of the plurality of fault events; and display the plurality of fault events based on the order.

Embodiment 5. The fault analysis system of any of Embodiment 1 through Embodiment 4, wherein: the target severity level comprises a lowest severity level; and the second severity level is higher than the target severity level.

Embodiment 6. The fault analysis system of any of Embodiment 1 through Embodiment 5, further comprising: one or more rule based tables, wherein the one or more processors are configured to generate the second fault event based on the fault event and the one or more rule based tables.

Embodiment 7. The fault analysis system of any of Embodiment 1 through Embodiment 6, wherein: the one or more processors are configured to assign the second severity level to the second fault event.

Embodiment 8. The fault analysis system of any of Embodiment 1 through Embodiment 7, wherein: the one or more processors are configured to generate a database entry corresponding to the fault event and store the database entry to a database; and the one or more processors are configured to generate a second database entry corresponding to the second fault event and store the second database entry to the database.

Embodiment 9. The fault analysis system of any of Embodiment 1 through Embodiment 8, wherein: the one or more processors are configured to generate first timestamp data associated with the fault event and second timestamp data associated with generation of the second fault event; and the one or more processors are configured to display the fault event and the second fault event based on the first timestamp data and the second timestamp data.

Embodiment 10. The fault analysis system of any of Embodiment 1 through Embodiment 9, wherein the one or more processors are further configured to:

generate one or more second corrective actions associated with the second fault event, wherein at least a portion of the one or more second corrective actions associated with the second fault event is different from one or more correction actions associated with the fault event.

Embodiment 11. The fault analysis system of any of Embodiment 1 through Embodiment 10, wherein the one or more processors are further configured to: determine a pattern associated with the instances of the fault event; and generate the second fault event based on comparing the pattern to a target pattern.

Embodiment 12. An apparatus, comprising: a controller including one or more processors and logic circuitry, wherein: processing circuitry of the one or more processors is configured to continuously capture status signals corresponding to a plurality of fault events, wherein the plurality of fault events are associated with an electric power generating system of an aircraft; the logic circuitry is configured to count a quantity of instances of a fault event of a target severity level with respect to a target quantity of flights, wherein the fault event is included in the plurality of fault events; the processing circuitry is configured to generate a second fault event associated with the fault event based on comparing, by the logic circuitry, the quantity of the instances to a threshold quantity, wherein the second fault event is of a second severity level different from the target severity level; and the processing circuitry is configured to report the second fault event according to the second severity level.

Embodiment 13. The apparatus of Embodiment 12, further comprising: a memory device comprising a circular buffer, wherein the processing circuitry is configured to continuously store the status signals to the circular buffer.

Embodiment 14. The apparatus of Embodiment 12 or Embodiment 13, wherein the logic circuitry is configured to classify the plurality of fault events according to respective severity levels of the plurality of fault events.

Embodiment 15. The apparatus of any of Embodiment 12 through Embodiment 14, wherein the processing circuitry is configured to: add the second fault event to the plurality of fault events; order the plurality of fault events based on respective severity levels of the plurality of fault events; and display the plurality of fault events based on the order.

Embodiment 16. A method comprising: continuously capturing, by one or more circuitry, status signals corresponding to a plurality of fault events, wherein the plurality of fault events are associated with an electric power generating system of an aircraft; counting, by the one or more circuitry, a quantity of instances of a fault event of a target severity level with respect to a target quantity of flights, wherein the fault event is included in the plurality of fault events; generating, by the one or more circuitry, a second fault event associated with the fault event based on comparing the quantity of the instances to a threshold quantity, wherein the second fault event is of a second severity level different from the target severity level; and reporting, by the one or more circuitry, the second fault event according to the second severity level.

Embodiment 17. The method of Embodiment 16, further comprising: continuously storing, by the one or more circuitry, the status signals to a circular buffer.

Embodiment 18. The method of Embodiment 16 or 17, further comprising: classifying, by the one or more circuitry, the plurality of fault events according to respective severity levels of the plurality of fault events.

Embodiment 19. The method of any of Embodiment 16 through Embodiment 18, further comprising: adding, by the one or more circuitry, the second fault event to the plurality of fault events; ordering, by the one or more circuitry, the plurality of fault events based on respective severity levels of the plurality of fault events; and displaying, by the one or more circuitry, the plurality of fault events based on the ordering.

Embodiment 20. The method of any of Embodiment 16 through Embodiment 19, wherein: the target severity level comprises a lowest severity level; and the second severity level is higher than the target severity level.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A fault analysis system, comprising:
one or more processors configured to:
continuously capture status signals corresponding to a plurality of fault events, wherein the plurality of fault events are associated with an electric power generating system of an aircraft;
count a quantity of instances of a fault event of a target severity level with respect to a target quantity of flights, wherein the fault event is included in the plurality of fault events;
generate a second fault event associated with the fault event based on comparing the quantity of the instances to a threshold quantity, wherein the second fault event is of a second severity level different from the target severity level; and
report the second fault event according to the second severity level.

2. The fault analysis system of claim 1, further comprising:
a memory device comprising a circular buffer,
wherein the one or more processors are configured to continuously store the status signals to the circular buffer.

3. The fault analysis system of claim 1, wherein the one or more processors are configured to classify the plurality of fault events according to respective severity levels of the plurality of fault events.

2. The fault analysis system of claim 1, wherein the one or more processors are further configured to:
add the second fault event to the plurality of fault events;
order the plurality of fault events based on respective severity levels of the plurality of fault events; and
display the plurality of fault events based on the order.

3. The fault analysis system of claim 1, wherein:
the target severity level comprises a lowest severity level; and
the second severity level is higher than the target severity level.

6. The fault analysis system of claim 1, further comprising:
one or more rule based tables, wherein the one or more processors are configured to generate the second fault event based on the fault event and the one or more rule based tables.

4. The fault analysis system of claim 1, wherein:
the one or more processors are configured to assign the second severity level to the second fault event.

5. The fault analysis system of claim 1, wherein:
the one or more processors are configured to generate a database entry corresponding to the fault event and store the database entry to a database; and
the one or more processors are configured to generate a second database entry corresponding to the second fault event and store the second database entry to the database.

6. The fault analysis system of claim 1, wherein:
the one or more processors are configured to generate first timestamp data associated with the fault event and second timestamp data associated with generation of the second fault event; and
the one or more processors are configured to display the fault event and the second fault event based on the first timestamp data and the second timestamp data.

10. The fault analysis system of claim 1, wherein the one or more processors are further configured to:
generate one or more second corrective actions associated with the second fault event,
wherein at least a portion of the one or more second corrective actions associated with the second fault event is different from one or more correction actions associated with the fault event.

7. The fault analysis system of claim 1, wherein the one or more processors are further configured to:
determine a pattern associated with the instances of the fault event; and
generate the second fault event based on comparing the pattern to a target pattern.

8. An apparatus, comprising:
a controller comprising one or more processors and logic circuitry,
wherein:
processing circuitry of the one or more processors is configured to continuously capture status signals corresponding to a plurality of fault events, wherein the plurality of fault events are associated with an electric power generating system of an aircraft;
the logic circuitry is configured to count a quantity of instances of a fault event of a target severity level with respect to a target quantity of flights, wherein the fault event is included in the plurality of fault events;
the processing circuitry is configured to generate a second fault event associated with the fault event based on comparing, by the logic circuitry, the quantity of the instances to a threshold quantity, wherein the second fault event is of a second severity level different from the target severity level; and
the processing circuitry is configured to report the second fault event according to the second severity level.

9. The apparatus of claim 12, further comprising:
a memory device comprising a circular buffer,
wherein the processing circuitry is configured to continuously store the status signals to the circular buffer.

10. The apparatus of claim 12, wherein the logic circuitry is configured to classify the plurality of fault events according to respective severity levels of the plurality of fault events.

11. The apparatus of claim 12, wherein the processing circuitry is configured to:
add the second fault event to the plurality of fault events;
order the plurality of fault events based on respective severity levels of the plurality of fault events; and
display the plurality of fault events based on the order.

12. A method comprising:
continuously capturing, by one or more circuitry, status signals corresponding to a plurality of fault events, wherein the plurality of fault events are associated with an electric power generating system of an aircraft;
counting, by the one or more circuitry, a quantity of instances of a fault event of a target severity level with respect to a target quantity of flights, wherein the fault event is included in the plurality of fault events;
generating, by the one or more circuitry, a second fault event associated with the fault event based on comparing the quantity of the instances to a threshold quantity, wherein the second fault event is of a second severity level different from the target severity level; and
reporting, by the one or more circuitry, the second fault event according to the second severity level.

13. The method of claim 16, further comprising:
continuously storing, by the one or more circuitry, the status signals to a circular buffer.

18. The method of claim 17, further comprising:
classifying, by the one or more circuitry, the plurality of fault events according to respective severity levels of the plurality of fault events.

19. The method of claim 17, further comprising:
adding, by the one or more circuitry, the second fault event to the plurality of fault events;
ordering, by the one or more circuitry, the plurality of fault events based on respective severity levels of the plurality of fault events; and
displaying, by the one or more circuitry, the plurality of fault events based on the ordering.

20. The method of claim 17, wherein:
the target severity level comprises a lowest severity level; and
the second severity level is higher than the target severity level.
